(19) United States
(12) Patent Application Publication
(10) Pub. No.: US 2026/0049903 A1
(43) Pub. Date: Feb. 19, 2026

(54) ACTUATOR APPARATUS, METHOD AND ELECTRONIC MONITORING DEVICE FOR MONITORING AN OPERATIONAL RELATIONSHIP BETWEEN A TRIGGER SIGNAL AND A CHECK SIGNAL

(71) Applicant: Samson Aktiengesellschaft, Frankfurt am Main (DE)

(72) Inventors: David Wagner-Stürz, Mühltal (DE); Jens Bieger, Mörfelden-Walldorf (DE); Guido König, Freigericht (DE); Daniel Herzmann, Frankfurt (DE); Torsten Jung, Frankfurt (DE)

(73) Assignee: Samson Aktiengesellschaft, Frankfurt am Main (DE)

(21) Appl. No.: 19/303,746

(22) Filed: Aug. 19, 2025

(30) Foreign Application Priority Data
Aug. 19, 2024 (DE) 102024123660.4

(51) Int. Cl. G01M 99/00; F16K 37/00

(52) U.S. Cl. CPC G01M 99/008; F16K 37/0083

(57) ABSTRACT

An actuator device for a process plant, such as a chemical, power, or food processing facility, includes a pneumatically operated control valve with an electrical actuator (e.g., I/P converter, solenoid valve, position controller, or drive) for performing a test function. At least one sensor verifies the test function and sends a signal describing the result. An electronic monitoring device, separate from the actuator, receives a trigger signal indicating when the test function starts and a functionally safe signal from the sensor. The device's electronic system monitors the relationship between the trigger and sensor signals to confirm correct operation.

### CROSS REFERENCE TO RELATED APPLICATIONS

This patent application claims priority to German Patent Application No. 102024123660.4, filed Aug. 19, 2024, which is incorporated herein by reference in its entirety.

### BACKGROUND

The disclosure relates to an actuator device of a process engineering plant, such as a chemical plant, a power plant, a food processing plant or the like, having a control valve, such as pneumatically operated control valve, and having an electronic monitoring device. The disclosure further relates to a method of the electronic monitoring device for monitoring a test function of the control valve.

From technical devices of any kind, by which both individual machines and entire process engineering plants are to be understood, certain hazards come not only directly for the operating personnel, but also indirectly for the environment and thus for uninvolved persons. The kind and the extent of the hazards depend here on a plurality of factors, such as for example on the properties of the respective technical device itself, but also on the operation thereof. Against this background, the legislator already prescribes the creation of a risk and hazard analysis in the planning phase of such dangerous technical devices. The identified risks and hazards in the intended operation of the technical device can be lowered to an acceptable level by the structural design of the technical device in accordance with legally established regulations.

The case of complex technical devices, such as process engineering plants, a so-called process control or process control system (PCS for short; also: basic process control system, BPCS for short) is required for establishing and maintaining an intended operating state. In that a process control system can correct deviations from the intended operating state which move within a limited range, it makes a contribution to the safe operation of a process engineering plant. In order to ensure that even strong deviations from the intended operating state which go beyond the corrective capability of the process control system do not lead to a safety-relevant event, process engineering plants are additionally equipped with a safety instrument system (SIS for short) which is independent of the process control system. While the process control system, in addition to its actual task—namely the process control—also makes a contribution to the safety of the process engineering plant to a certain extent, the task of the safety system consists solely in transferring the process engineering plant back into a safe state in the event of the occurrence of safety-critical operating states. For this purpose, a safety system (SIS) may comprise at least one so-called safety instrumented function (SIF for short), which is generally implemented in the form of a sensor, an actuator and an electronic safety-oriented controller, which is also referred to as a logic module. The safety-oriented controller determines—independently of the process control system—on the basis of the information supplied by the sensors whether a safety-critical operating state of the process engineering plant is present and whether an intervention of the safety system in the form of the execution of a safety instrumented function, which is also referred to as a safety function, is required.

Although it is the task of the safety system to transfer a process engineering plant back into a safe state in the event of the occurrence of a safety-critical operating state, there is of course also the risk of a malfunction or a failure for the safety system. The associated probability must be taken into account in the creation of a risk and hazard analysis of a process engineering plant. Depending on the requirements for the safety of the process engineering plant as a whole, certain requirements result for the failsafety of the safety system. These requirements for the failsafety of a safety function are quantified by means of a so-called safety integrity level (SIL for short), which indicates the probability of failure if necessary. A probability of failure if necessary of >=10⁻² to <10⁻¹ is referred to as SIL1, a probability of failure if necessary of >=10⁻³ to <10⁻² as SIL2, a probability of failure if necessary of >=10⁻⁴ to <10⁻³ as SIL3 and finally a probability of failure if necessary of >=10⁻⁵ to <10⁻⁴ as SIL4. Equivalently, a safety requirement level can also be expressed by the corresponding risk reduction factor: thus SIL1 corresponds to a risk reduction factor of 10 to 100, SIL2 corresponds to a risk reduction factor of 100 to 1000, SIL3 corresponds to a risk reduction factor of 1000 to 10 000 and SIL4 corresponds to a risk reduction factor of 10 000 to 100 000.

According to the requirements with respect to the probability of failure if necessary, which are made to a safety instrumented function, the components used for the implementation of the safety instrumented function must also have a SIL certification of the required level. In order to demonstrate the functional capability of the individual components, regular checks are required.

In the case of a safety instrumented function, the actuator of which is configured in the form of a control valve, a safety instrumented function can consist, for example, in transferring the control valve from a permanently open state into a closed state. In order that the control valve also actually closes if necessary and does not, for example, remain fixed, its functional capability must be checked at regular intervals. Such a functionality check may comprise not only the check as to whether the valve spindle is movable at all, but also whether it is movable over the entire actuating travel. While the first-mentioned check can be carried out by means of a so-called partial stroke test (PST) during the ongoing operation of the process engineering plant, a full stroke test (FST) is generally accompanied by a temporary process shutdown and consequently by financial losses for the operator of the process engineering plant.

For this reason, the number of full stroke tests is restricted to the minimum absolutely necessary for ensuring the SIL requirements and the termination thereof is adapted to any planned standstill and maintenance periods. In order to lengthen the intervals between full stroke tests—within the limits set by the SIL requirements—partial stroke tests can increasingly be carried out. Although the execution of a relatively large number of partial stroke tests on the one hand prevents financial losses for the operator of a process engineering plant that would arise as a result of a process shutdown, on the other hand it entails an increased personnel outlay. In addition, a relatively large number of partial stroke tests to be executed is not only accompanied by an increased documentation outlay but, owing to the risk of human errors that can never be ruled out, also by an increased risk of an inadequate execution of a partial stroke test.

Against this background, the German publication document DE 10 2004 015 617 A1 is concerned with the question of how the risk of a human error can be eliminated or at least reduced during the execution of a partial stroke test on a control valve. The starting point of the publication document DE 10 2004 015 617 A1 is given by a safety system (“safety system”) which is integrated in a process control system (“process control system”) and is used in process engineering plants. The field devices of the process engineering plant can in this case be equipped with so-called online self-testing routines (on-line self-tests) which are stored on the field devices. In order to trigger these online self-testing routines, the maintenance personnel must temporarily connect to the field device to be tested a further device which is equipped with corresponding maintenance software and can trigger the online self-testing routines. The publication document DE 10 2004 015 617 A1 names the risks associated with the use of maintenance personnel, such as, for example, an inadequate execution of the test or a test at the wrong time, as disadvantages. As a further disadvantage of a manual triggering of the online self-testing routines by the maintenance personnel, the publication document DE 10 2004 015 617 A1 mentions the risk that, although the test is executed correctly and in good time, the process control and security system nevertheless does not gain any knowledge of the test results because of a human failure.

In order to completely eliminate or at least minimize these risks associated with the use of maintenance personnel, the publication document DE 10 2004 015 617 A1 proposes the use of so-called testing blocks (“testing blocks”) which are located in the network hierarchy (see FIG. 2) at the level of so-called input/output devices (“input/output (I/O)) devices”) and therefore above the level of the field devices. Said testing blocks communicate with the field devices and trigger the online self-testing routines stored in the field devices (“on-line self-tests”). The testing blocks are furthermore able to detect the results of the online self-testing routines and to transmit them to higher levels in the network hierarchy (see FIG. 2), which enables the user located at the level of the workstations to monitor the operating status of the field devices. The use of testing blocks according to the publication document DE 10 2004 015 617 A1 eliminates the need for maintenance personnel which triggers the online self-testing routines stored in the field devices, and therefore also the disadvantages associated therewith.

Despite the automated remote triggering of the online self-testing routines by the testing blocks and their ability to transmit the results of the online self-testing routines to the user located at a higher level, the publication document DE 10 2004 015 617 A1 does not fully exploit the potential of the testing blocks. It is therefore an object of the disclosure to overcome the disadvantages of the prior art, in particular to provide an actuator device having a control valve, for which an operational relationship between a trigger signal which triggers a test function of an electric actuator of the control valve and a check signal which describes the check of the execution of the test function is monitored by means of an electronic monitoring device.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1A shows an actuating device according to an exemplary embodiment of the disclosure.

FIG. 1B shows an actuating device according to an exemplary embodiment of the disclosure.

FIG. 2 shows an actuating device for a partial stroke test according to an exemplary embodiment of the disclosure.

FIG. 3 shows a schematic illustration of a safety system of a process engineering plant according to an exemplary embodiment of the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

According to the disclosure, an actuator device of a process engineering plant, such as a chemical plant, a power plant, a food-processing plant or the like, having a control valve, such as a pneumatically operated control valve, is provided.

According to the disclosure, the control valve in this case may comprise an electric actuator, such as an I/P converter or a solenoid valve of a position controller or a drive or an independent solenoid valve, which is configured for executing a test function.

According to the disclosure, the control valve additionally may comprise at least one sensor for checking the execution of the test function and for transmitting a check signal which describes the execution of the test function.

According to the disclosure, the control valve additionally may comprise an electronic monitoring device which may be configured separately from the electric actuator.

According to the disclosure, the electronic monitoring device which may be configured separately from the electric actuator may comprise an input for receiving an electric trigger signal which signals a point in time of the triggering of the test function and a further input which is configured in a functionally safe manner for receiving the check signal of the at least one sensor.

According to the disclosure, an electronic system of the electronic monitoring device is configured in such a way that an operational relationship between the check signal and the trigger signal is monitored.

According to an exemplary embodiment of the actuator device which can be combined with other exemplary embodiments, the at least one sensor, such as a SIL-certified sensor, can be a limit contactor, a pressure sensor or a stroke sensor.

According to an exemplary embodiment of the actuator device which can be combined with other exemplary embodiments, the trigger signal can be a binary signal which is output by the electric actuator.

According to an exemplary embodiment of the actuator device which can be combined with other exemplary embodiments, the input for receiving an electric trigger signal can be configured in a functionally safe manner and can be connected to a safety circuit of the process engineering plant via an Ethernet APL connection.

According to an exemplary embodiment of the actuator device which can be combined with other exemplary embodiments, the input which is configured in a functionally safe manner can comprise a combination of a functionally safe communication protocol and a communication connection which functions as a black channel.

According to an exemplary embodiment of the actuator device which can be combined with other exemplary embodiments, the functionally safe communication protocol can be a PROFIsafe protocol or a CIPsafety protocol.

According to an exemplary embodiment of the actuator device which can be combined with other exemplary embodiments, the communication connection which functions as a black channel can be an Ethernet APL connection.

According to an exemplary embodiment of the actuator device which can be combined with other exemplary embodiments, the execution of a test function can be the execution of a partial or full stroke test of the control valve.

According to an exemplary embodiment of the actuator device which can be combined with other exemplary embodiments, the check signal which describes the execution of the test function can contain information about a start, an end and/or a profile of the execution of the test function.

According to an exemplary embodiment of the actuator device which can be combined with other exemplary embodiments, the information about the course of the execution of the test functions can indicate the switching of a boundary contact, the duration up to the switching of a boundary contact, the duration up to the switching and the duration up to the switching back of a boundary contact, the evaluation of a time course of a stroke movement, the evaluation of a total stroke which is traveled, the evaluation of a time course of a pressure, the evaluation of a pressure difference and/or the evaluation of a pressure change rate.

According to an exemplary embodiment of the actuator device which can be combined with other exemplary embodiments, the check signal which describes the execution of the test function can contain information about a time course of the execution of the test function, wherein the monitoring of an operational relationship between the check signal and the trigger signal can comprise a division of the time course into different movement ranges of the test function.

According to an exemplary embodiment of the actuator device which can be combined with other exemplary embodiments, the monitoring of an operational relationship between the check signal and the trigger signal can comprise a determination of the presence of a specific signal course in the check signal which can correlate, such as in terms of time, with the triggering of the switching function.

According to an exemplary embodiment of the actuator device which can be combined with other exemplary embodiments, the monitoring of an operational relationship between the check signal and the trigger signal can comprise a determination of a time offset between the two signals and a comparison of the time offset with a stored or previously determined reference value.

According to an exemplary embodiment of the actuator device which can be combined with other exemplary embodiments, the electronic monitoring device can comprise an output which may be configured in a functionally safe manner for outputting a control signal to the electric actuator as a function of the trigger signal, wherein the control signal can be provided for actuating the actuator for triggering the test function.

According to an exemplary embodiment of the actuator device which can be combined with other exemplary embodiments, the output which may be configured in a functionally safe manner for outputting a control signal to the electric actuator can comprise a combination of a functionally safe communication protocol and a communication connection which functions as a black channel.

According to the disclosure, a method of an electronic monitoring device, which may be configured separately from an electric actuator for an actuator device of a process engineering plant, such as a chemical plant, a power plant, a food-processing plant or the like, is provided. The actuator device may comprise a control valve, such as a pneumatically operated control valve. The control valve may comprise:
an electric actuator, such as an I/P converter or a solenoid valve of a position controller or a drive or an independent solenoid valve, which is configured for executing a test function, and
at least one sensor for checking the execution of the test function and for transmitting a check signal which describes the execution of the test function.

According to the disclosure, the method may comprise receiving an electric trigger signal for the test function at an input of the electronic monitoring device, wherein the trigger signal signals a point in time of the triggering of the execution of the test function.

According to the disclosure, the method may further comprise receiving a check signal of the at least one sensor at a further input of the electronic monitoring device, wherein the further input is configured in a safe manner.

According to the disclosure, the method may further comprise monitoring an operational relationship between the check signal and the trigger signal by an electronic system of the electronic monitoring device.

According to an exemplary embodiment of the method which can be combined with other exemplary embodiments, the at least one sensor, such as a SIL-certified sensor, can be a limit contactor, a pressure sensor or a stroke sensor.

According to an exemplary embodiment of the method which can be combined with other exemplary embodiments, the trigger signal can be a binary signal which is output by the electric actuator.

According to an exemplary embodiment of the method which can be combined with other exemplary embodiments, an input for receiving an electric trigger signal can be configured in a functionally safe manner and can be connected to a safety circuit of the process engineering plant via an Ethernet APL connection.

According to an exemplary embodiment of the method which can be combined with other exemplary embodiments, the input which is configured in a functionally safe manner can comprise a combination of a functionally safe communication protocol and a communication connection which functions as a black channel.

According to an exemplary embodiment of the method which can be combined with other exemplary embodiments, the functionally safe communication protocol can be a PROFIsafe protocol or a CIPsafety protocol.

According to an exemplary embodiment of the method which can be combined with other exemplary embodiments, the communication connection which functions as a black channel can be an Ethernet APL connection.

According to an exemplary embodiment of the method which can be combined with other exemplary embodiments, the execution of a test function can be the execution of a partial or full stroke test.

According to an exemplary embodiment of the method which can be combined with other exemplary embodiments, the check signal which describes the execution of the test function can contain information about a start, an end and/or a profile of the execution of the test function.

According to an exemplary embodiment of the method which can be combined with other exemplary embodiments, the information about the course of the execution of the test functions can indicate the switching of a boundary contact, the duration up to the switching of a boundary contact, the duration up to the switching and the duration up to the switching back of a boundary contact, the evaluation of a time course of a stroke movement, the evaluation of a total stroke which is traveled, the evaluation of a time course of a pressure, the evaluation of a pressure difference and/or the evaluation of a pressure change rate.

According to an exemplary embodiment of the method which can be combined with other exemplary embodiments, the check signal which describes the execution of the test function can contain information about a time course of the execution of the test function, wherein the monitoring of an operational relationship between the check signal and the trigger signal can comprise a division of the time course into different movement ranges of the test function.

According to an exemplary embodiment of the method which can be combined with other exemplary embodiments, the monitoring of an operational relationship between the check signal and the trigger signal can consist in a determination of the presence of a specific signal course in the check signal which can correlate, such as in terms of time, with the triggering of the switching function.

According to an exemplary embodiment of the method which can be combined with other exemplary embodiments, the monitoring of an operational relationship between the check signal and the trigger signal can comprise a determination of a time offset between the two signals and a comparison of the time offset with a stored or previously determined reference value.

According to an exemplary embodiment of the method which can be combined with other exemplary embodiments, the output which may be configured in a functionally safe manner for outputting a control signal to the electric actuator can comprise a combination of a functionally safe communication protocol and a communication connection which functions as a black channel.

According to the disclosure, an electronic monitoring device for an actuator device of a process engineering plant, such as a chemical plant, a power plant, a food-processing plant or the like, is provided.

According to the disclosure, the electronic monitoring device may comprise an input for receiving an electric trigger signal which signals a point in time of the triggering of a test function of an electric actuator, such as an I/P converter or a solenoid valve of a position controller or a drive or an independent solenoid valve.

According to the disclosure, the electronic monitoring device may further comprise a further input which is configured in a functionally safe manner for receiving a check signal of at least one sensor which is configured for checking the execution of the test function and for transmitting a check signal which describes the execution of the test function.

According to the disclosure, the electronic monitoring device is configured separately from the electric actuator, having an electronic system which is configured in such a way that an operational relationship between the check signal and the trigger signal is monitored.

According to an exemplary embodiment of the electronic monitoring device which can be combined with other exemplary embodiments, the at least one sensor, such as a SIL-certified sensor, can be a limit contactor, a pressure sensor or a stroke sensor.

According to an exemplary embodiment of the electronic monitoring device which can be combined with other exemplary embodiments, the trigger signal can be a binary signal which is output by the electric actuator.

According to an exemplary embodiment of the electronic monitoring device which can be combined with other exemplary embodiments, the input for receiving an electric trigger signal can be configured in a functionally safe manner and can be connected to a safety circuit of the process engineering plant via an Ethernet APL connection.

According to an exemplary embodiment of the electronic monitoring device which can be combined with other exemplary embodiments, the input which is configured in a functionally safe manner can comprise a combination of a functionally safe communication protocol and a communication connection which functions as a black channel.

According to an exemplary embodiment of the electronic monitoring device which can be combined with other exemplary embodiments, the functionally safe communication protocol can be a PROFIsafe protocol or a CIPsafety protocol.

According to an exemplary embodiment of the electronic monitoring device which can be combined with other exemplary embodiments, the communication connection which functions as a black channel can be an Ethernet APL connection.

According to an exemplary embodiment of the electronic monitoring device which can be combined with other exemplary embodiments, the execution of a test function can be the execution of a partial or full stroke test.

According to an exemplary embodiment of the electronic monitoring device which can be combined with other exemplary embodiments, the check signal which describes the execution of the test function can contain information about a start, an end and/or a profile of the execution of the test function.

According to an exemplary embodiment of the electronic monitoring device which can be combined with other exemplary embodiments, the information about the course of the execution of the test functions can indicate the switching of a boundary contact, the duration up to the switching of a boundary contact, the duration up to the switching and the duration up to the switching back of a boundary contact, the evaluation of a time course of a stroke movement, the evaluation of a total stroke which is traveled, the evaluation of a time course of a pressure, the evaluation of a pressure difference and/or the evaluation of a pressure change rate.

According to an exemplary embodiment of the electronic monitoring device which can be combined with other exemplary embodiments, the check signal which describes the execution of the test function can contain information about a time course of the execution of the test function, wherein the monitoring of an operational relationship between the check signal and the trigger signal can comprise a division of the time course into different movement ranges of the test function.

According to an exemplary embodiment of the electronic monitoring device which can be combined with other exemplary embodiments, the monitoring of an operational relationship between the check signal and the trigger signal can consist of a determination of the presence of a specific signal course in the check signal which can correlate, such as in terms of time, with the triggering of the switching function.

According to an exemplary embodiment of the electronic monitoring device which can be combined with other exemplary embodiments, the monitoring of an operational relationship between the check signal and the trigger signal can comprise a determination of a time offset between the two signals and a comparison of the time offset with a stored or previously determined reference value.

According to an exemplary embodiment of the electronic monitoring device which can be combined with other exemplary embodiments, the output which is configured in a functionally safe manner for outputting a control signal to the electric actuator can comprise a combination of a functionally safe communication protocol and a communication connection which functions as a black channel.

According to an exemplary embodiment of the electronic monitoring device which can be combined with other exemplary embodiments, the electronic system of the electronic monitoring device, such as a computing unit (processing circuitry), can be configured in a functionally safe manner.

According to an exemplary embodiment of the actuator device which can be combined with other exemplary embodiments, the control valve can comprise an electric actuator, such as a drive or a control valve or safety valve, which is provided in at least one operating state for a safety function of the control valve, such as driving into a safety position; at least one sensor for checking a switching capability of the electric actuator for the safety function and for transmitting a check signal which describes the switching capability; and an electronic monitoring device which may be configured separately from the electric actuator, wherein the electronic monitoring device which may be configured separately from the electric actuator can comprise an output which is configured in a functionally safe manner for triggering a switching function of the electric actuator, and an input which is configured in a functionally safe manner for receiving the check signal of the at least one sensor, wherein an electronic system of the electronic monitoring device can be configured in such a way that an operational relationship between the check signal and the trigger signal can be monitored.

According to an exemplary embodiment of the actuator device which can be combined with other exemplary embodiments, the electric actuator can be a safety valve, such as a solenoid valve.

According to an exemplary embodiment of the actuator device which can be combined with other exemplary embodiments, during the checking of the switching capability of the electric actuator, a position of an actuator of the control valve can remain substantially unchanged during the triggering of the switching function.

According to an exemplary embodiment of the actuator device which can be combined with other exemplary embodiments, the electronic monitoring device can be configured in an intrinsically safe manner.

According to an exemplary embodiment of the actuator device which can be combined with other exemplary embodiments, the energy supply of the electronic monitoring device can take place via an Ethernet APL connection.

According to an exemplary embodiment of the actuator device which can be combined with other exemplary embodiments, the energy supply of the electric actuator and/or of the at least one sensor can take place by the electronic monitoring device.

According to an exemplary embodiment of the actuator device which can be combined with other exemplary embodiments, the electronic monitoring device can be connected to a safety system of the process engineering plant via an Ethernet APL connection.

According to an exemplary embodiment of the actuator device which can be combined with other exemplary embodiments, the at least one sensor, such as a SIL-certified sensor, can be a pressure sensor.

According to an exemplary embodiment of the actuator device which can be combined with other exemplary embodiments, the at least one sensor, such as a SIL-certified sensor, can be a limit contactor and the control valve can additionally comprise a stroke sensor, such as a SIL-certified stroke sensor.

According to an exemplary embodiment of the actuator device which can be combined with other exemplary embodiments, the functionally safe communication protocol can be a PROFIsafe protocol or a CIPsafety protocol.

According to an exemplary embodiment of the actuator device which can be combined with other exemplary embodiments, the triggering of a switching function of the electric actuator can be a movement of a component, such as an armature, of the actuator.

According to an exemplary embodiment of the actuator device which can be combined with other exemplary embodiments, the check signal which describes the switching capability can contain information about a start, an end and/or a profile of the switching function.

According to an exemplary embodiment of the actuator device which can be combined with other exemplary embodiments, the information about the course of the execution of the test functions can indicate the switching of a boundary contact, the duration up to the switching of a boundary contact, the duration up to the switching and the duration up to the switching back of a boundary contact, the evaluation of a time course of a stroke movement, the evaluation of a total stroke which is traveled, the evaluation of a time course of a pressure, the evaluation of a pressure difference and/or the evaluation of a pressure change rate.

According to an exemplary embodiment of the actuator device which can be combined with other exemplary embodiments, the monitoring of an operational relationship between the check signal and the trigger signal can comprise a determination of the presence of a specific signal course in the check signal which can correlate, such as in terms of time, with the triggering of the switching function.

According to an exemplary embodiment of the actuator device which can be combined with other exemplary embodiments, the monitoring of an operational relationship between the check signal and the trigger signal can comprise a determination of a time offset between the two signals and a comparison of the time offset with a stored or previously determined reference value.

According to an exemplary embodiment of the actuator device which can be combined with other exemplary embodiments, the electronic monitoring device can comprise a further connection which can be configured in a functionally safe manner and via which the electronic monitoring device can be connected to a safety system.

According to an exemplary embodiment of the actuator device which can be combined with other exemplary embodiments, the further connection which is configured in a functionally safe manner can comprise a combination of a functionally safe communication protocol and a communication connection which functions as a black channel.

According to an exemplary embodiment of the method which can be combined with other exemplary embodiments, the method can comprise triggering a switching function of the electric actuator at an output of the electronic monitoring device which is configured in a functionally safe manner; receiving a check signal of the at least one sensor at an input of the electronic monitoring device which is configured in a functionally safe manner; and monitoring an operational relationship between the check signal and the triggering of the switching function by an electronic system of the electronic monitoring device.

According to an exemplary embodiment of the method which can be combined with other exemplary embodiments, the electric actuator can be a safety valve, such as a solenoid valve.

According to an exemplary embodiment of the method which can be combined with other exemplary embodiments, during the checking of the switching capability of the electric actuator, a position of an actuator of the control valve can remain substantially unchanged during the triggering of the switching function.

According to an exemplary embodiment of the method which can be combined with other exemplary embodiments, the electronic monitoring device can be configured in an intrinsically safe manner.

According to an exemplary embodiment of the method which can be combined with other exemplary embodiments, the energy supply of the electronic monitoring device can take place via an Ethernet APL connection.

According to an exemplary embodiment of the method which can be combined with other exemplary embodiments, the energy supply of the electric actuator and/or of the at least one sensor can take place by the electronic monitoring device.

According to an exemplary embodiment of the method which can be combined with other exemplary embodiments, the electronic monitoring device can be connected to a safety system of the process engineering plant via an Ethernet APL connection.

According to an exemplary embodiment of the method which can be combined with other exemplary embodiments, the at least one sensor, such as a SIL-certified sensor, can be a pressure sensor.

According to an exemplary embodiment of the method which can be combined with other exemplary embodiments, the at least one sensor, such as a SIL-certified sensor, can be a limit contactor and the control valve can additionally comprise a stroke sensor, such as a SIL-certified stroke sensor.

According to an exemplary embodiment of the method which can be combined with other exemplary embodiments, the functionally safe communication protocol can be a PROFIsafe protocol or a CIPsafety protocol.

According to an exemplary embodiment of the method which can be combined with other exemplary embodiments, the triggering of a switching function of the electric actuator can be a movement of a component, such as an armature, of the actuator.

According to an exemplary embodiment of the method which can be combined with other exemplary embodiments, the check signal which describes the switching capability can contain information about a start, an end and/or a profile of the switching function.

According to an exemplary embodiment of the method which can be combined with other exemplary embodiments, the information about the course of the execution of the test functions can indicate the switching of a boundary contact, the duration up to the switching of a boundary contact, the duration up to the switching and the duration up to the switching back of a boundary contact, the evaluation of a time course of a stroke movement, the evaluation of a total stroke which is traveled, the evaluation of a time course of a pressure, the evaluation of a pressure difference and/or the evaluation of a pressure change rate.

According to an exemplary embodiment of the method which can be combined with other exemplary embodiments, the monitoring of an operational relationship between the check signal and the trigger signal can comprise a determination of the presence of a specific signal course in the check signal which can correlate, such as in terms of time, with the triggering of the switching function.

According to an exemplary embodiment of the method which can be combined with other exemplary embodiments, the monitoring of an operational relationship between the check signal and the trigger signal can comprise a determination of a time offset between the two signals and a comparison of the time offset with a stored or previously determined reference value.

According to an exemplary embodiment of the method which can be combined with other exemplary embodiments, the electronic monitoring device can comprise a further connection which can be configured in a functionally safe manner and via which the electronic monitoring device can be connected to a safety system.

According to an exemplary embodiment of the method which can be combined with other exemplary embodiments, the further connection which is configured in a functionally safe manner can comprise a combination of a functionally safe communication protocol and a communication connection which functions as a black channel.

According to an exemplary embodiment of the electronic monitoring device which can be combined with other exemplary embodiments, the electronic monitoring device can comprise an output which is configured in a functionally safe manner for triggering a switching function of the electric actuator; and an input which is configured in a functionally safe manner for receiving the check signal of the at least one sensor, wherein an electronic system of the electronic monitoring device is configured in such a way that an operational relationship between the check signal and the triggering of the switching function can be monitored.

According to an exemplary embodiment of the electronic monitoring device which can be combined with other exemplary embodiments, the electric actuator can be a safety valve, such as a solenoid valve.

According to an exemplary embodiment of the electronic monitoring device which can be combined with other exemplary embodiments, during the checking of the switching capability of the electric actuator, a position of an actuator of the control valve can remain substantially unchanged during the triggering of the switching function.

According to an exemplary embodiment of the electronic monitoring device which can be combined with other exemplary embodiments, the electronic monitoring device can be configured in an intrinsically safe manner.

According to an exemplary embodiment of the electronic monitoring device which can be combined with other exemplary embodiments, the energy supply of the electronic monitoring device can take place via an Ethernet APL connection.

According to an exemplary embodiment of the electronic monitoring device which can be combined with other exemplary embodiments, the energy supply of the electric actuator and/or of the at least one sensor can take place by the electronic monitoring device.

According to an exemplary embodiment of the electronic monitoring device which can be combined with other exemplary embodiments, the electronic monitoring device can be connected to a safety system of the process engineering plant via an Ethernet APL connection.

According to an exemplary embodiment of the electronic monitoring device which can be combined with other exemplary embodiments, the at least one sensor, such as a SIL-certified sensor, can be a pressure sensor.

According to an exemplary embodiment of the electronic monitoring device which can be combined with other exemplary embodiments, the at least one sensor, such as a SIL-certified sensor, can be a limit contactor and the control valve can additionally comprise a stroke sensor, such as a SIL-certified stroke sensor.

According to an exemplary embodiment of the electronic monitoring device which can be combined with other exemplary embodiments, the functionally safe communication protocol can be a PROFIsafe protocol or a CIPsafety protocol.

According to an exemplary embodiment of the electronic monitoring device which can be combined with other exemplary embodiments, the triggering of a switching function of the electric actuator can be a movement of a component, such as an armature, of the actuator.

According to an exemplary embodiment of the electronic monitoring device which can be combined with other exemplary embodiments, the check signal which describes the switching capability can contain information about a start, an end and/or a profile of the switching function.

According to an exemplary embodiment of the electronic monitoring device which can be combined with other exemplary embodiments, the information about the course of the execution of the test functions can indicate the switching of a boundary contact, the duration up to the switching of a boundary contact, the duration up to the switching and the duration up to the switching back of a boundary contact, the evaluation of a time course of a stroke movement, the evaluation of a total stroke which is traveled, the evaluation of a time course of a pressure, the evaluation of a pressure difference and/or the evaluation of a pressure change rate.

According to an exemplary embodiment of the electronic monitoring device which can be combined with other exemplary embodiments, the monitoring of an operational relationship between the check signal and the trigger signal can comprise a determination of the presence of a specific signal course in the check signal which can correlate, such as in terms of time, with the triggering of the switching function.

According to an exemplary embodiment of the electronic monitoring device which can be combined with other exemplary embodiments, the monitoring of an operational relationship between the check signal and the trigger signal can comprise a determination of a time offset between the two signals and a comparison of the time offset with a stored or previously determined reference value.

According to an exemplary embodiment of the electronic monitoring device which can be combined with other exemplary embodiments, the electronic monitoring device can comprise a further connection which can be configured in a functionally safe manner and via which the electronic monitoring device can be connected to a safety system.

According to an exemplary embodiment of the electronic monitoring device which can be combined with other exemplary embodiments, the further connection which is configured in a functionally safe manner can comprise a combination of a functionally safe communication protocol and a communication connection which functions as a black channel.

A “drive” which can optionally also be referred to as an “actuator” can generally be understood to mean a drive element which converts electric, pneumatic, hydraulic or other input signals into mechanical movements or into the change of physical variables as output signals. Depending on the type of input signal and optionally of the output signal, actuators can be divided into different categories, such as, for example, mechanical, acoustic, thermal or pneumatic actuators. Thus, for example, an actuator which converts an electric input signal into a pneumatic output signal can be referred to as an electric or—more specifically—as an electropneumatic actuator. Such an electric or electropneumatic actuator can be, for example, an I/P converter. Specifically in the context of actuators, both the actuator in its entirety and also only a part of the actuator can be referred to as an actuator. Such a part of an actuator can be, for example, an actuating drive.

An “actuating drive” which can also be referred to as a “drive” for short can be understood to mean that part of an actuator which generates the movement of the actuator. In this case, actuating drives can be classified according to the type of auxiliary energy used (pneumatic, hydraulic, electromagnetic, manual, etc.), according to the design principle (piston, diaphragm, magnet coil, handwheel, hand lever, etc.) and/or according to the type of actuating movement (rectilinear, pivoting, rotating, etc.). A typical example of actuating drives in process engineering plants—in particular in explosive environments—are pneumatic actuating drives.

A “position controller” which can optionally also be referred to as a “positioner” can be understood to mean an accessory for actuating valves, the basic function of which is to compare the position of the valve spindle or of the valve shaft as a controlled variable with an input signal as a reference variable and, in the event of deviations of the controlled variable from the reference variable, to change the actuating pressure such that the controlled variable approximates or at least approximates the reference variable. While older position controllers received the reference variable in the form of pneumatic input signals, modern position controllers are usually digital position controllers which can receive the reference variable in the form of electric signals. These signals can be processed by executing algorithms on a microprocessor (and/or using other processing circuitry) of the digital position controller, which can in turn output an electric signal to a current/pressure converter (I/P converter for short) as an output variable. The I/P converter can in turn output a pressure signal which can either be intended directly for a pneumatic actuating drive or—which is generally the case—can initially also be amplified by a pressure amplifier. In the case of electric actuating drives, i.e. for actuating drives which use electric energy as auxiliary energy, the need for an I/P converter and the need for a pressure amplifier can be dispensed with. If an I/P converter is not considered to be a separate component, but is instead included in the position controller, this can be referred to as electropneumatic position controllers. Such microprocessor-controlled, electropneumatic position controllers can form the standard in modern process engineering plants.

A “solenoid valve” can be understood to mean a valve which is installed in the pneumatic connecting line between a position controller and a pneumatic actuating drive and can be switched by means of an electromagnet. Depending on the intended function of the solenoid valve in the event of a power failure, the switching off of the electromagnet can either lead to venting of the actuating drive or to the air located in the actuating drive being enclosed there. Through the use of an electromagnet, solenoid valves can switch very quickly, which can represent an important characteristic in particular with regard to safety functions.

A “test function” can be understood to mean a check of one or more functionalities. A functionality to be checked can be a functionality of an actuating device as an overall unit or a functionality of a subunit of the actuating device comprised by the actuating device. Such a subunit of an actuating device can be, for example, an actuator. A functionality of an actuator as a subunit of an actuating device can be, for example, an only minimal, a partial or a complete movement of a valve spindle of an actuating device. In the special case of a control valve, a test function can be, for example, a partial stroke test (PST for short) or a full stroke test (FST for short). In the case of a partial stroke test on a control valve, the functionality to be checked of the control valve can be the movability of a valve spindle over a part of the overall stroke path. Typically, with a partial stroke test, the movability of a spindle can be checked starting from a position of the valve spindle which corresponds to a completely open state of the control valve or a completely closed state of the control valve. However, with a partial stroke test, the movability of a spindle can also be checked starting from a position of the valve spindle which corresponds neither to a completely open nor to a completely closed state of the control valve. In the case of a full stroke test on a control valve, the functionality to be checked of the control valve can be the movability of a valve spindle over an overall stroke path.

A “sensor” can generally be understood to mean the counterpart of an actuator in a control circuit: While an actuator as a drive element can convert electric, pneumatic, hydraulic or other input signals into mechanical movements or into the change of physical variables as output signals, a sensor can detect, for example, mechanical movements or other physical, chemical or other qualitatively or quantitatively determinable variables or states and generate an electric signal therefrom. In the specific case in which an actuator can be configured for executing a test function, a sensor can check the execution of the test function. The “check” can in this case not be subject to any restriction in terms of time: Thus, the term “check” can comprise, for example, both a check which takes place at one or more points in time, a check which takes place in specific time intervals or at specific time intervals, but also a permanent check. Independently of the time dimension of the term “check”, this term can be understood to mean both a determination or determination in the sense of a punctiform check, but also a monitoring in the sense of a continuous check. Specifically in the case of a partial stroke test on a control valve, the check of the execution of the partial stroke test can consist, for example, in the determination of whether the valve spindle has left an initial position. Alternatively or additionally, the check can also consist in the determination of at what point in time the valve spindle has left an initial position and/or with what time delay after the start of the execution of the partial stroke test the valve spindle has left an initial position. The term “initial position” can in this case be understood to mean a position of the valve spindle at the point in time immediately before the start of the execution of the partial stroke test; this initial position can be a lower end position, an upper end position or any desired position between a lower and an upper end position. Likewise, the check of the execution of the partial stroke test can consist, for example, in the recording or determination of a time-path, time-speed and/or time-acceleration profile of the movement of the valve spindle. Specifically in the case of a full stroke test on a control valve, the check of the execution of the partial stroke test can consist, for example, in the determination of whether the valve spindle has left a first end position. A first end position can be an upper end position or a lower end position. Alternatively or additionally, the check can also consist in the determination of at what point in time the valve spindle has left a first end position and/or with what time delay after the start of the execution of the full stroke test the valve spindle has left a first end position. Furthermore, the check of the execution of a full stroke test can comprise the determination of whether the valve spindle has reached a second end position. A second end position can be—complementary to a first end position—a lower end position or an upper end position. Alternatively or additionally, the check can also consist in the determination of at what point in time the valve spindle has reached a second end position and/or with what time delay after the start of the execution of the full stroke test the valve spindle has reached a second end position. Likewise as in the case of the check of the execution of a partial stroke test, the check of the execution of a full stroke test can also consist in the recording or determination of a time-path, time-speed and/or time-acceleration profile of the movement of the valve spindle.

A “check signal which describes the execution of the test function” can be understood to mean a signal which contains information about the execution of the test function. In this case, the “check signal” can comprise only the data about the execution of the test function which are determined by a single sensor; alternatively, the check signal can also comprise the data of a plurality of sensors. Likewise, the “check signal” can be interpreted as the entirety of two or more signals, wherein each signal can comprise the data about the execution of the test function which are determined by a single sensor. In this case, the “check signal which describes the execution of the test function” can generally comprise all conceivable data and information which can be determined by sensors and describe one or more aspects of the execution of a test function.

A check signal can originate, for example, from a limit contactor which can also be referred to as a limit signal transmitter or limit contact. Such a check signal can indicate the switching of the contact and/or the switching back of the contact. Likewise, such a check signal can indicate the duration up to the switching of the contact and/or the duration up to the switching back of the contact.

A check signal can originate, for example, from a stroke sensor. Such a check signal can indicate the reaching of a defined stroke value, the evaluation of a time course of a stroke movement and/or the evaluation of the total stroke which is traveled. Likewise, such a check signal can indicate a division of the time course of the stroke movement into different movement ranges: whereas for a full stroke test the entire stroke travel has to be traveled and the check signal accordingly generally also indicates the time course of the entire stroke movement, it may be sufficient for partial stroke tests that only specific parts of the time course of the entire stroke movement are indicated.

A check signal can originate, for example, from a pressure sensor. Such a check signal can indicate the reaching of a defined pressure, the reaching of a defined pressure change, the evaluation of a time course of the pressure and/or the evaluation of a pressure difference. Likewise, such a check signal can indicate a division of the time course of the pressure into different states. Furthermore, such a check signal can indicate the evaluation of a pressure change rate or indicate information which allows the evaluation of a pressure change rate.

Examples of check signals can be the following signals:
Position feedback analog from the position controller, 4-20 mA, externally fed at the electronic monitoring device at a functionally safe analog input (Possible functions: feedback and monitoring of the valve movement during a PST/FST or switching process; monitoring of the valve dynamics/running times; verification of the limit contacts for the position feedback; feedback of further variables of the position controller, e.g. values of internal pressure sensors for supply air or drive pressure of the position controller)
Analog feedback signal from the position controller, 4-20 mA, externally fed at the electronic monitoring device at a functionally safe analog input (Possible functions: safe feedback and monitoring of different analog variables of the position controller on the same line via a time-multiplexed analog signal with subdivided different value ranges, such as, for example, 4-6 mA for value 1, 6-8 mA for value 2, 8-10 mA for value 3 etc. to 20 mA)
Analog feedback signal from the position controller, 4-20 mA, externally fed at the electronic monitoring device at a functionally safe analog input, additionally a digital signal in the case of position controller and electronic monitoring device for synchronizing the switching time (Possible functions: safe feedback and monitoring of different analog variables of the position controller on the same line via a time-multiplexed analog signal with subdivided different value ranges, such as, for example, 4-6 mA for value 1, 6-8 mA for value 2, 8-10 mA for value 3 etc. to 20 mA)
Safe position feedback analog from type 4749, 4-20 mA, externally fed at the electronic monitoring device at a functionally safe analog input (Possible functions: safe feedback and safe monitoring of the valve movement during a PST/FST or switching process; monitoring of the valve dynamics/running times, replacement of the function of the limit contacts)
Limit contact feedback (Possible functions: safe feedback of the reaching or leaving of the end positions; in the case of PST/FST, safe recognition of the valve movement; monitoring of the valve dynamics/running times of open/closed running time; in combination with the digital input of the position controller feedback for running PST/FST)
Wear sensor packing, functionally safe digital output on functionally safe digital input of the electronic monitoring device (Possible functions: safe feedback of packing wear before the occurrence of the leakage of the valve housing)
Safe pressure sensor in the output of the solenoid valve with analog pressure measurement signal to functionally safe analog input of the electronic monitoring device (Possible functions: safe detection of the pressure drop in the case of brief switching off of the solenoid valve without the armature moving out of the end position by a short pulse at the safe digital output of the electronic monitoring device to the solenoid valve to prove the function of the solenoid valve.
Functionally safe switching output of the electronic monitoring device to the solenoid valve (Possible function: safe line breakage detection and feedback by short test pulse current)
SIL NAMUR Limit contacts at functionally safe digital input of the electronic monitoring device (Possible functions: wire breakage monitoring or short circuit and safe feedback by NAMUR status signaling)
Functionally safe or unsafe flowmeter with analog output to functionally safe analog input of the electronic monitoring device (Possible functions: safe feedback of the line flow and monitoring of the sealing closure in combination with the safe limit contact; safe detection and feedback of relevant leakage; safe feedback of the line flow for monitoring the flow of a medium, e.g. for ensuring a cooling application)
Functionally safe digital output of the electronic monitoring device to a digital input of the position controller (Possible functions: safe signaling of a running solenoid valve test for suppressing any error messages of the position controller on account of position changes by the pressure drop of the test; safe signaling of a safety switch-off by the DIO to the position controller for suppressing an error message; avoidance of the ventilation of the drive by the position controller in the case of actuation of the safety position by the electronic monitoring device)
Functionally safe analog input with a safe pressure sensor connected for measuring the supply air pressure (Possible functions: safe feedback for ensuring the presence of the primary drive energy)
Reliable analog input connected with an acceleration sensor which detects any form of vibrations at the valve (Possible functions: safe feedback of a flow or greater cavitation in the valve in the open position in combination with the limit contacts; safe feedback of a missing flow or ensure that no leakage is present in the closed position in combination with the limit contacts)
Functionally safe digital output of a first electronic monitoring device to a safe digital input of a second electronic monitoring device (Possible functions: in the case of higher SIL levels (3 and higher), two valve armatures are required for implementation with in each case one electronic monitoring device. In this case, there are two cases to be distinguished:
   1.) Safety function is the safe closing: here, two actuators are connected in series (Possible functions: the first electronic monitoring device reports the safety position of its actuator back (closed) to the second electronic monitoring device via the signal. Then, the second electronic monitoring device can safely carry out and feedback a complete movement test. The first electronic monitoring device reports this state to the position controller via the additional safe digital output and triggers an FST/PST test.)
   2.) Safety function is the safe opening: here, two actuators are connected in parallel (Possible functions: the first electronic monitoring device reports the safety position of its actuator back (open) to the second via the signal. Then, the second electronic monitoring device can safely carry out and feedback a complete movement test. The first electronic monitoring device reports this state to the position controller via the additional safe digital output and triggers an FST/PST test.)
Functionally safe digital output to a (functionally safe) external device or sensor (Possible functions: the safe digital output triggers a simulation mode of a (functionally safe) analog or digital output of a device or sensor which is detected via in each case one safe input of the electronic monitoring device; thus, the (functionally safe) function of the information can be tested or diagnosed by the connected device via a predefined and internally known temporal sequence of expected values.)

An “electronic monitoring device” can be understood to mean an electronic apparatus which can send, receive and process electric signals. The device may include processing circuitry configured to perform the functions/operations of the device. For example, the processing of the electric signals can take place here by means of suitable algorithms using a microprocessor. “Separate configuration” of an electronic monitoring device from an electric actuator can be understood to mean a separation or separability of the functionalities of the electronic monitoring device from the functionalities of the electric actuator in the sense that the functionalities of the electric actuator do not depend on the presence or absence of the electronic monitoring device. This can mean that the electronic monitoring device can be, for example, an optional device on or in the electric actuator; a separation in the sense of a physical distance of the electronic monitoring device from the electric actuator may not be necessary. Likewise, the electronic monitoring device can be retrofittable in the sense of an accessory on or in the electric actuator.

An “input” of the electronic monitoring device can be understood here to mean an interface of the electronic monitoring device, via which the electronic monitoring device can receive electric signals. The received electric signals can be distinguished here to the effect whether they relate to the process control system or the safety system. In the event that the received electric signals are in connection with the execution or monitoring of a safety function and are thus part of the safety system, in order to be able to achieve a predefined safety requirement level, the signal transmission can also satisfy the respective SIL requirements. Thus, for example, it can be ensured that the electric signals are not falsified as a result of electromagnetic interference or other influences; likewise, for example, it can be ensured that no external electric signals can be introduced or electric signals can be lost via an interface. Furthermore, for example, it can be ensured that the electric signals can be received in the correct sequence and that no delays or signal repetitions can occur. In order to be able to limit the probability of the occurrence of such errors to a level which can satisfy the respective SIL requirements, an input which can be involved in the signal transmission in the safety circuit can be configured in a “functionally safe manner.”

As failsafe as possible a configuration of a binary electric output for actuating a solenoid valve, in which the safe state is the currentless state, can be realized by a plurality of circuit-technical measures and diagnostic measures. The technical aspects and measures for diagnosing and increasing the functional safety are presented in more detail below.

An SIL-compliant output stage for actuating a solenoid valve can be realized by using a relay output stage. In this case, the output for actuating the solenoid valve may comprise a relay which is closed in the normal state and closes the circuit. In the event of a fault state or energy loss, the relay opens the circuit, as a result of which the safe, currentless state of the solenoid valve is reached. Likewise, an SIL-compliant output stage for actuating a solenoid valve can be realized by using a redundant power supply. In this case, a double power supply is used which may comprise a primary and a secondary voltage source. In the event of failure of the primary source, the secondary source takes over the supply.

An SIL-compliant output stage for actuating a solenoid valve can additionally be realized by including various diagnostic measures. An SIL-compliant output stage for actuating a solenoid valve can be achieved, for example, by connecting a readback input to a sensor which monitors the actual state of the solenoid valve. This sensor reports back a signal to the controller which reflects the current switching state of a relay. This gives rise to a feedback loop which provides information about whether the current switching state of a relay corresponds to the current setpoint state. An SIL-compliant output stage for actuating a solenoid valve can additionally be realized, for example, by monitoring current intensities and voltages at the solenoid valve and at the relay. Thus, a current flowing through the solenoid valve can be measured by means of a shunt resistor connected in series with the latter. In addition, voltage sensors can be used to monitor the voltage at the relay output and at the solenoid valve. These sensors are connected to a monitoring unit which continuously checks the measured values and detects deviations.

The functional reliability can additionally be increased by the redundant design of the control channel (“dual channel”), by the use of diagnostic logic and by the performance of online self-tests. In the redundant design of the control channel, a solenoid valve is actuated simultaneously via two mutually independent control channels (“dual channel”), each of which is equipped with its own relay. Both channels are designed such that they operate independently of one another and their outputs are regularly compared with one another. A fault in one of the two channels is detected and reported by comparison with the other channel. In addition, there is the possibility of implementing a diagnostic logic in the controller which continuously checks the state of the relays, the read-back signals and the measured values of the current and voltage sensors. Upon detection of a fault pattern, the logic puts the system into the safe state. Furthermore, the controller can regularly carry out self-tests in which the relay is briefly switched and the feedback signals are checked. These self-tests are carried out automatically and during normal operation (“online”) without impairing the function of the solenoid valve.

These specific implementations ensure the functional safety according to SIL2 and SIL3 by minimizing the probability of dangerous failures and reliably putting the system into the safe state in the event of a fault.

As failsafe as possible a configuration of a binary electric input, via which digital NAMUR signals are received, can also be realized by a plurality of circuit-technical measures and diagnostic measures. The technical aspects and measures for diagnosing and increasing the functional safety are presented in more detail below.

An SIL-compliant input stage for digital NAMUR signals can be continuously monitored, for example, by using a single-precision analog-digital converter (ADC) in combination with a shunt resistor, the current flow through the inputs in order to ensure that it remains within the NAMUR limit values. Deviations, such as an excessively low current (line interruption) or an excessively high current (short circuit), are immediately detected and reported. Such a circuit with a high-resistance voltage divider and comparator recognizes the specific voltage levels of the NAMUR signal (0-1 mA as low and 2.1-6 mA as high). In addition, the input stage can be galvanically isolated from the rest of the system by means of an optocoupler in order to ensure protection against interference voltages and overvoltages.

An SIL-compliant input stage for digital NAMUR signals can additionally be realized by including various diagnostic measures. Thus, for example, the current intensity can be continuously measured by means of a current monitoring circuit which may comprise a shunt resistor and a precise analog-digital converter (ADC). In the case of current intensities <0.1 mA, a line interruption is detected in this case, whereas in the case of current intensities >6 mA, a short circuit is detected. An SIL-compliant input stage for digital NAMUR signals can additionally be realized via a readback input circuit. By an additional input circuit monitoring the actual state of an input signal and feeding it back to the controller, a feedback loop arises with which the correct reception and state of the signal can be checked. Furthermore, an SIL-compliant input stage for digital NAMUR signals can be realized via a signal integrity check. In this case, an algorithm implemented in the controller continuously checks the signal integrity and in this way recognizes anomalies in the signal profile.

The functional reliability can additionally be increased by the redundant design of the input channel (“dual channel”), by the use of diagnostic logic and by the performance of online self-tests. In the redundant design of the input channel, two separate input channels (“dual channel”) detect the same NAMUR signal. Both channels are designed such that they operate independently of one another and their inputs are regularly compared with one another. A fault in one of the two channels is detected and reported by comparison with the other channel. In addition, there is the possibility of implementing a diagnostic logic in the controller which is realized in the form of a microcontroller or an FPGA (“field programmable gate array”) and continuously checks the states of the inputs, the read-back signals and the results of the line monitoring. Upon detection of a fault pattern, the logic puts the system into the safe state. Furthermore, the controller can regularly carry out self-tests in that a test signal generator contained in the controller regularly sends test signals to the NAMUR inputs during normal operation (“online”). A corresponding monitoring processor checks the feedback signals and evaluates their integrity. Furthermore, a precise analog-digital converter (ADC) in combination with a shunt resistor can continuously monitor the current flow through the inputs in order to ensure that it remains within the NAMUR limit values. Deviations, such as an excessively low current intensity which indicates a line interruption or an excessively high current intensity which indicates a short circuit, can thereby be immediately detected and reported.

These specific implementations ensure the functional safety according to SIL2 and SIL3 for digital NAMUR signals by minimizing the probability of dangerous failures and reliably putting the system into the safe state in the event of a fault.

In addition to the measures described above for ensuring as failsafe as possible a configuration of a binary electric output for actuating a solenoid valve and of a binary electric input for receiving digital NAMUR signals, some general circuit-technical measures and diagnostic methods which can be used to realize functionally safe binary outputs according to SIL2 and SIL3 are explained below.

In the field of circuit-technical measures, the functional safety can in principle be increased by a redundant design of channels, components or entire system. By using a so-called “dual-channel architecture” in which two output channels operate independently of one another and are compared at regular intervals, faults in one of the channels can be detected and the failsafety can thus be increased. By virtue of the fact that components or entire systems are present multiple times and are operated simultaneously, it is possible to switch over to a redundant system in the event of a fault.

further circuit-technical measure for increasing the functional safety consists in diversifying both the hardware used and the software used. By using different hardware and software components in parallel channels for fault detection and fault avoidance, the functional safety can be increased since different implementations are less likely to have the same fault. Thus, for example, a relay can be used as a switch in one channel, whereas a MOSFET is used as a switch in a parallel channel.

The functional safety can furthermore be increased by using so-called “watchdog timers”: these monitoring circuits ensure that the system regularly checks its own function and, in the event of anomalies, passes safely into a defined state.

In principle, the functional safety can be increased by configuring circuits such that, in the event of the occurrence of a fault, a safe state (e.g. shutdown of a machine) is automatically assumed. The use of components which are designed for higher current intensities and voltages than occur or are necessary in normal operation can also increase the failsafety.

further circuit-technical measure for increasing the functional safety consists in the integration of self-test mechanisms (“built-in self-test”) which periodically or if necessary check the function of the hardware. This increases the probability that a fault is detected in good time—or at all—and corresponding measures can be initiated.

In addition to the purely circuit-technical measures, diagnostic measures can also contribute to an increase in the functional safety.

In the field of diagnostic measures, the functional safety can in principle be increased by measures for fault detection and fault diagnosis. This can take place, for example, by means of the calculation and the comparison of check bits (“parity check”) and check sums (“cyclic redundancy check”) for checking the data integrity. In addition, the testing of the logical functions by means of targeted inputs and checking of the outputs is also considered as a measure.

further diagnostic measure with which the functional safety can be increased consists in the monitoring of operating current strengths and operating voltages in order to detect possible anomalies in good time—or at all. The temperature of critical components can likewise be monitored in order to prevent possible overheating damage.

The functional safety can also be increased by fault events and system states for diagnosis and analysis being recorded after a fault event (“logging”). By virtue of faults not only being detected but rather their causes being identified, future faults can possibly be avoided.

further measure for increasing the functional safety consists in the regular execution of diagnostic routines which check the functionality of individual components and if necessary initiate maintenance measures. Such a continuous monitoring and diagnosis can in this case be carried out during operation (“online”) without interruption of the normal functions.

As a result of the combination of these measures and diagnoses, systems can meet the requirements for functional safety according to SIL2 and SIL3 by minimizing the probability of dangerous failures and ensuring the detection and reaction to faults.

The functionally safe configuration of an input can require the use of a communication protocol with which the previously listed faults can be detected. If a communication protocol would not detect the mentioned faults, a safety system could not trust the received signals and the data which are transmitted therewith. If, for example, it could not be guaranteed that the probability for an external signal introduced via an input lies below a certain acceptable threshold, a safety system could not provide the evidence, which is necessary for a specific safety integrity level, about the failsafety of a safety function. Although it could of course be the simplest to handle any communication via functionally safe communication protocols, this could be associated with disproportionately high costs. On account of the fact that it may be the case that only a specific part of the communication in process engineering plants has to meet particularly high requirements with regard to failsafety, a standard communication protocol can in principle be used in process engineering plants and this can be supplemented only at the relevant points by a functionally safer communication protocol which is based on the standard communication protocol; the underlying standard communication protocol can be referred to as a “black channel” in this case. In this case, the standard communication protocol can be, for example, the Profibus protocol, an Ethernet protocol or an Industrial Ethernet protocol which is based thereon, such as the Profinet protocol. In addition, however, any other conceivable communication protocol can also be used; in particular, the signal transmission can take place on the physical layer (PHY for short) of such a communication protocol, for example in a wired or wireless manner, but also using an optical waveguide.

The functionally safe communication protocol which is based on a standard communication protocol can use various measures in order to detect the previously listed faults which can occur when electric signals are received by the electronic monitoring device. Thus, for example, a faulty reception sequence of transmitted data packets can be ruled out by virtue of the transmitted data packets being consecutively numbered; in this way, the loss of one or more data packets can additionally also be detected. By virtue of the data packets being able to be provided with a unique transmitter and receiver identifier, faulty electric signals can be detected, for example. For the detection of faulty components of a data packet which arise as a result of electromagnetic interference or other influences, a cyclic redundancy check (CRC for short) can additionally be used, for example. These and further safety measures can be implemented, for example, in the PROFIsafe communication protocol or in a CIPsafety protocol. The use of the PPROFIsafe communication protocol together with any desired communication connection as an underlying “black channel” can lead to an input of the electronic monitoring unit which is configured in a “functionally safe manner.”

A “trigger signal” can be understood to mean a signal which indicates at least one point in time of the triggering of a test function. This point in time can be, for example, that point in time at which the trigger signal was generated; alternatively, the point in time of the triggering of the test function can also be a point in time which is determined for a specific time period after the generation of the trigger signal. Optionally, the trigger signal can additionally comprise further information, such as, for example, the type of triggered test function (e.g. partial stroke test, full stroke test, etc.) and/or the duration provided for the execution of the test function. Furthermore, the trigger signal can also comprise information about the apparatus which triggers the test function and/or information about the apparatus which is intended for the execution of the test function.

The trigger signal can be received at an input of the electronic monitoring device which—in contrast to a further input at which a check signal is received by at least one sensor—cannot necessarily be configured in a functionally safe manner. The lack of need for a functionally safe configuration of the input at which the trigger signal is received can result from the fact that the trigger signal does not have to originate from the safety system, but rather can also originate from an instance within the process control system. By contrast, the input at which a check signal can be received by at least one sensor can be configured in a functionally safe manner in order to be able to make a safety-resistant statement about the execution of the test function.

Finally, the monitoring of an “operational relationship” between a check signal and a trigger signal can be understood to mean the checking, determination and/or determination of a causal relationship between the two signals. The monitoring of an operational relationship by an electronic system of the electronic monitoring device can consist, for example, in the checking whether the reception of a check signal is preceded in terms of time by the reception of a trigger signal. Although a check signal is received, but there is no trigger signal preceding in terms of time, the electronic monitoring device can determine the absence of an operational relationship. This can be attributed, for example, to the fact that the check signal was erroneously generated by a sensor, although no test function was triggered; however, this can also be attributed to the fact that a test function was triggered, but the corresponding trigger signal has reached only the electric actuator, but not the electronic monitoring device. Conversely, although a trigger signal is present, but no check signal follows, an operational relationship can likewise be absent. This can be attributed, for example, to the fact that an output signal was erroneously registered at the input of the electronic monitoring device; however, this can also be attributed to the fact that a test function was triggered, but the electric actuator does not execute the test function. In the case of a partial stroke test, this can be attributed, for example, to the fact that the control valve is fixed in an upper or lower end position. While the absence of a trigger signal can indicate at most a faulty connection between the apparatus which outputs the trigger signal and the electronic monitoring device and therefore cannot directly represent a safety-critical situation, the absence of a check signal can be far more critical despite a previously received trigger signal: even if this can possibly be attributed only to a faulty connection between the at least one sensor and the electronic monitoring device, the cause of the absence of a check signal can also be a functional failure of the control valve. If both a trigger signal and a check signal are received, the monitoring of an operational relationship can consist, for example, in the determination of a time offset between the point in time of the reception of the trigger signal and the point in time of the reception of the check signal. Likewise, the monitoring of an operational relationship can comprise, in addition to the actual determination of an offset, also the comparison of the determined offset with a reference value for the offset which is stored previously or by the manufacturer and/or a previously determined value for the offset. The correspondence of a determined value for the offset with a reference value or a previously determined value for the offset can indicate, for example, a correct functioning of a safety function. Likewise, in the case of the reception of a trigger signal and a check signal, the monitoring of an operational relationship can consist in a comparison of information which may comprise the trigger signal with information which may comprise the check signal. If the trigger signal may comprise, for example, information with respect to the duration of the provided duration of the execution of a test function, this duration can be compared with the actual duration of the execution of a test function. If, for example, a partial stroke test is executed as a test function but lasts longer than provided, the electronic monitoring device can determine a non-operational relationship despite the execution. Even in the case where the check signal indicates a non-uniform execution of a test function, such as, for example, a greatly fluctuating speed of the movement of a valve spindle in the case of a partial stroke or full stroke test which does not correspond to a time-speed profile to be expected according to the trigger signal, the electronic monitoring device can determine a non-operational relationship. In more general terms, the monitoring of an operational relationship between a trigger signal and a check signal can consist in the fact that the signals are examined for the presence of specific patterns, wherein, for example, the presence of a specific pattern or the presence of a specific sequence of a plurality of specific patterns indicates the presence of an operational relationship. Likewise, the presence of other specific patterns can also indicate the absence of an operational relationship. The examination of the signals for the presence of specific patterns can take place, for example, by virtue of the fact that the signals are compared with previously known patterns. In addition to these examples, the monitoring of an operational relationship between a received trigger signal and a check signal received via an input which is configured in a functionally safe manner can also consist in other comparisons between the trigger signal and the check signal. The determination of an operational relationship between a check signal and a trigger signal can serve as evidence that a safety-instrumented function which may comprise the actuator valve satisfies specific requirements with respect to failsafety, such as, for example, the requirements according to SIL1, SIL2, SIL3 or SIL4. If such evidence is transmitted to the safety system, the safety system can document—with knowledge of the SIL levels of the other components of a safety-instrumented function—that a safety-instrumented function can correspond to the requirements of a specific SIL level.

In the context of control valves, a “limit contactor” which can also be referred to as an “end position switch” can be understood to mean in this case a sensor which, in the form of a binary signal, gives feedback about the reaching of an upper or lower end position by the valve spindle. Limit contactors can play an important role in particular in the performance of partial stroke and full stroke tests: Even if a limit contactor does not deliver any information whatsoever about the profile of the execution of a partial stroke or full stroke test, said limit contactor can nevertheless reliably provide information about whether the valve spindle has at least set itself in motion. In general, the control valve can comprise further sensors in addition to a limit contactor, with the result that—as already explained further above—the check signal which describes the execution of the test function can also comprise further data from other sensors in addition to the data generated by a limit signal transmitter.

In the context of control valves having a pneumatic drive, a “pressure sensor” can be understood to mean a sensor which gives feedback about the pressure prevailing in a chamber of the pneumatic drive and also about pressure changes and/or pressure fluctuations.

In the context of control valves, a “stroke sensor” can be understood to mean a sensor which determines the stroke of a closure element in the interior of the control valve.

In this case, an “SIL, certification” of a component can be understood to mean—independently of stroke sensors—a confirmation that evidence has been provided for the relevant component that the failure probability thereof lies within specific predefined limits. In order that a safety-instrumented function consisting of different components as a whole can satisfy specific requirements with respect to failsafety, all the components of the safety-instrumented function can have to satisfy the respective requirement with respect to failsafety. In other words: that component of a safety-instrumented function having the highest failure probability (i.e. having the lowest SIL level) can determine the failure probability of the safety-instrumented function as a whole. If, in a safety-instrumented function, for example with the exception of a component which satisfies an SIL2 certification (failure probability in the case of need from >=10⁻³ to <10⁻²), exclusively components having an SIL3 certification (failure probability in the case of need from >=10⁻⁴ to <10⁻³) are used, the safety-instrumented function as a whole can nevertheless only achieve an SIL2 certification; the one component having an SIL2 certification can form the “weakest link” within the safety-instrumented function with respect to failsafety.

In this case, an “Ethernet Advanced Physical Layer (APL) connection” can be understood to mean a configuration—specifically tailored to the requirements of process engineering plants—of the lowest protocol layer—considered in the OSI model, namely the physical layer (PHY for short), of an Ethernet protocol. In principle, Ethernet protocols from the family of the IEEE standards 802.3 are a definition of the configuration of the first protocol layer (PHY for short)—considered in the OSI model—and of the second protocol layer (data link layer) located directly thereabove. In addition to the transmission medium and the plug connections, the first protocol layer also specifies, inter alia, the coding. In this case, “Ethernet APL” is understood to mean a specific Ethernet protocol from the family of the IEEE standards 802.3; this specific Ethernet protocol differs from other Ethernet protocols exclusively in the lowest protocol layer, for which reason the terms “Ethernet APL connection” and “Ethernet APL connection” can also be used. In addition to the provision of current and communication signals via a single 2-wire cable, an Ethernet APL connection and an Ethernet APL connection can be designed, under the aspect of intrinsic safety, primarily for operation within explosive areas, which is an essential requirement in particular in the process industry.

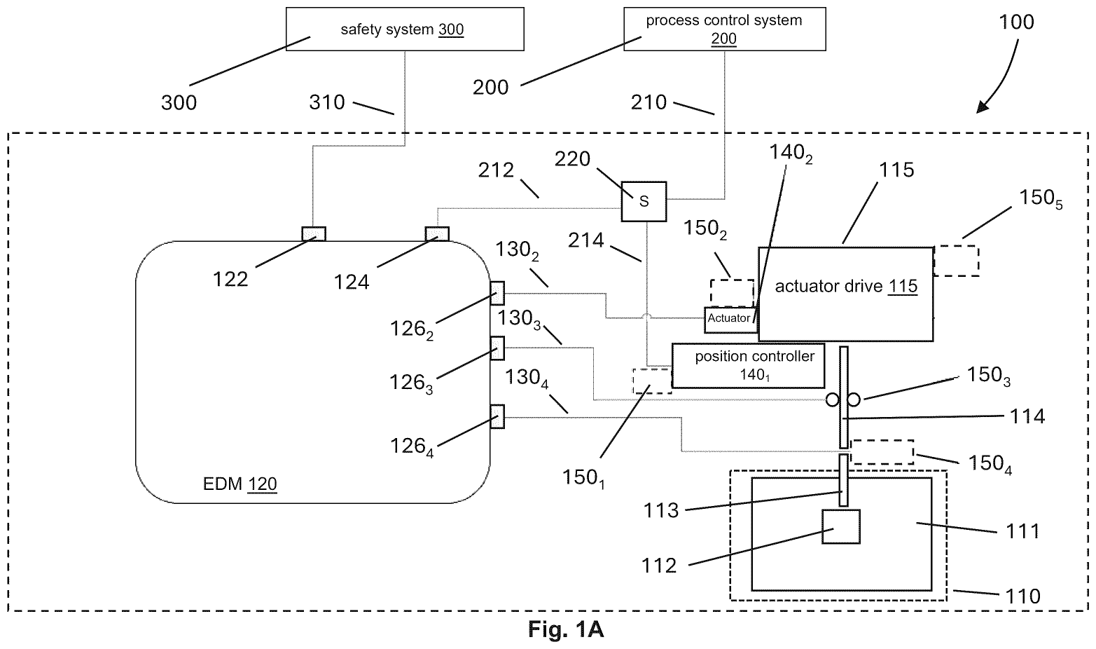

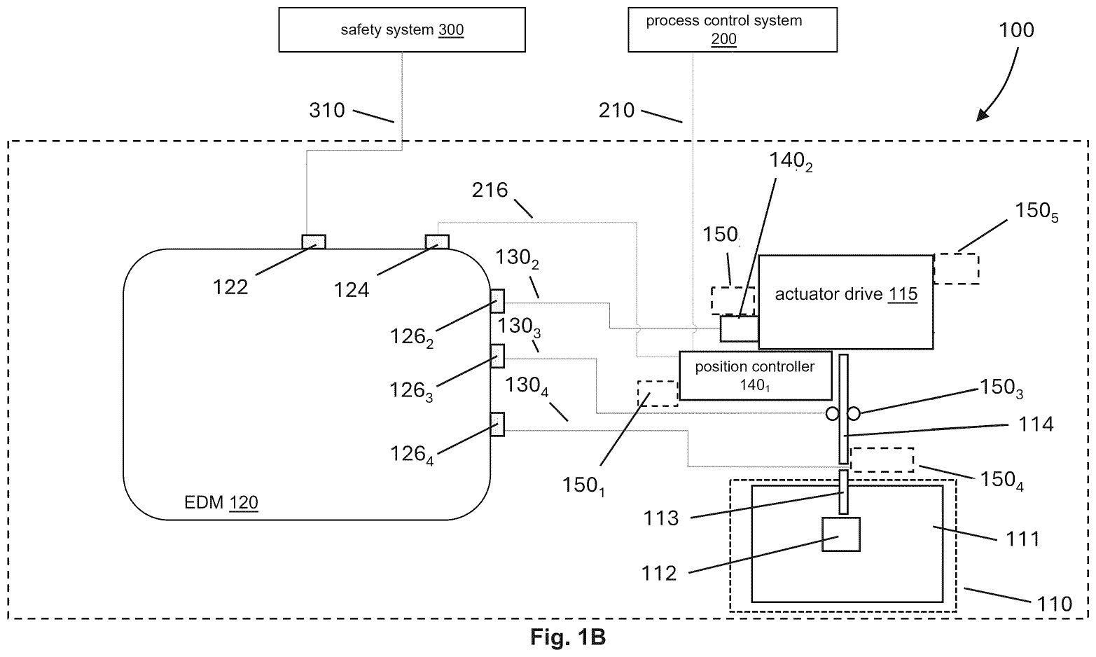

FIG. 1A shows an exemplary embodiment of an actuating device (100) which is connected to a process control system (200) via a connection (210) and is additionally also connected to a safety system (300) via a further connection (310). Each of the connections (210, 310) can consist—independently of the respective other connection—of one or more lines. Furthermore, each of the connections (210, 310) can serve—independently of the respective other connection—exclusively for communication. In addition, each of the two connections (210, 310) can serve—independently of the respective other connection—for the energy supply of the actuator device or of a part of the actuator device. Each of the two connections (210, 310) can be—independently of the respective other connection—for example a Profibus connection, an Ethernet connection or an Industrial Ethernet connection which is based thereon, such as, for example, a Profinet connection or an Ethernet APL connection.

According to the illustration, the actuator device (100) may comprise a control valve (110) and an electronic monitoring device (120) which is configured separately from the control valve and which is connected to the control valve according to the illustration via a plurality of connections (130₂, 130₃, 130₄). Each of the connections (130₂, 130₃, 130₄) can consist—independently of the respective other connections—of one or more lines. Furthermore, each of the connections (130₂, 130₃, 130₄) can serve—independently of the respective other connections—exclusively for communication. In addition, each of the connections (130₂, 130₃, 130₄) can serve—independently of the respective other connections—for the energy supply of the control valve or of a part or add-on part of the control valve.

According to the illustration, the control valve (110) may comprise—as viewed from bottom to top—the actual valve body (111) and, in the interior thereof, the valve cone (112) which is located according to the illustration in a lower end position, which means that the control valve is closed. The valve spindle (113) adjoins the upper end, according to the illustration, of the valve cone (112); at its upper end according to the illustration, said valve spindle is in turn connected to the drive spindle (114) which for its part produces the connection to the actuating drive (115) which according to the illustration is an inversely acting pneumatic diaphragm drive. As can be seen in FIG. 1A, the actuating drive consists of two chambers, wherein springs are arranged in the upper chamber according to the illustration. This arrangement leads to the control valve (110) being opened increasingly further with rising pressure in the actuating drive (115); conversely, this means that the actuating drive (115) leads to a closed control valve (110) in the completely vented state.

According to the illustration, the control valve (110) is equipped with a plurality of actuators (140₁, 140₂). Said actuators are drive elements which convert input signals into mechanical movements or into the change of physical variables as output signals. Depending on the type of input signal and/or of the output signal, actuators can be divided into different categories, such as, for example, mechanical, acoustic, thermal or pneumatic actuators. According to the illustration, the actuator (140₁) is a position controller which can comprise one or more actuators, such as, for example, an I/P converter and/or a solenoid valve, while the actuator (140₂) is an independent solenoid valve which is independent of a position controller.

The position controller (140₁) is connected to the process control system (200) via the connection (214) which according to the illustration passes upwards (“upstream”) into the connection (210). The position controller (140₁) receives instructions from the process control system as a reference variable with respect to the position of the control valve or of the valve spindle (113) which is to be set. The position controller (140₁) compares the actual position of the control valve or of the valve spindle with this reference variable and changes the actuating pressure with the aim of minimizing existing deviations between the reference variable and the controlled variable. In addition to this, the position controller (140₁) reports back the current position of the control valve or of the valve spindle (113) to the process control system. The instructions received from the position controller (140₁) with respect to the position of the control valve or of the valve spindle which is to be set can also be the subject matter of the triggering of a test function. In this case, the position controller (140₁) receives a trigger signal from the process control system (200), which trigger signal is conducted via a switch (220) to the branch (212) and/or also to an electronic monitoring device (120) and is received there at an input (124). In this case, the connection (210) and the two branches (212, 214) do not have to be configured in a functionally reliable manner. The switch—if the connection (124) functions as an output—can also be designed in such a way as to switch a signal from the electronic monitoring device (120) to the position controller (140₁).

The independent solenoid valve (140₂) is connected via a connection (130₂) to an output (126₂) of the electronic monitoring device (120) which is configured in a functionally reliable manner.

According to the illustration, the control valve (110) is further equipped with one or a plurality of sensors (150₁, 150₂, 1503, 1504, 150₅) which can be arranged at different positions of the control valve and can be configured for monitoring different parameters. Thus, the sensor (150₃) can be, for example, a limit contactor. According to the illustration, the latter is connected via a connection (130₃) to an input (126₃) of the electronic monitoring device (120) which is configured in a functionally reliable manner. According to the illustration, a further sensor (150₄) which can be, for example, a position sensor is connected via a connection (130₄) to a further input (126₄) of the electronic monitoring device (120) which is configured in a functionally reliable manner. Alternatively, the sensor (150₄) can also be any desired other sensor, such as, for example, a stroke sensor. Likewise, the sensors—as indicated by way of example by the position of the sensor (150₅)—can be arranged at any desired other points of the control valve. These sensors are likewise each connected to a further input of the electronic monitoring device (120) which is configured in a functionally reliable manner; however, the connection which is then to be designated as (150₅) and the input which is to be designated as (126₅) and is configured in a functionally reliable manner have not been illustrated in FIG. 1A for reasons of clarity. Furthermore—as indicated by way of example by the positions of the sensors (150₁, 150₂)—the actuators (140₁, 140₂) themselves can also be equipped with one or a plurality of sensors which would then likewise have to be connected via corresponding connections to functionally reliable inputs of the electronic monitoring device (120).

According to the illustration, in addition to the input (124) which is not necessarily configured in a functionally reliable manner and via which a trigger signal for a test function can be received, and in addition to the inputs (126₃, 126₄) which are configured in a functionally reliable manner and via which check signals can be received by the sensors, the electronic monitoring device (120) also may comprise a connection (126₂) which is configured in a functionally reliable manner and which is connected to the independent solenoid valve (1402) and can be configured as an output (1262) in the present exemplary embodiment. In addition, the electronic monitoring device can comprise a further connection (122) which is configured in a functionally reliable manner and which can simultaneously function as an input and as an output. Via this connection (122), the electronic monitoring device (120) can on the one hand be supplied with energy and/or data by the safety system (300); on the other hand, the electronic monitoring device (120) can for its part transmit information about the presence of an operational relationship between a check signal and a trigger signal to the safety system (300) via this connection (122). The presence of an operational relationship between a check signal and a trigger signal can serve, for example, as evidence that a safety-instrumented function satisfies specific requirements with respect to failsafety.

In this case, the usability of information about the presence of an operational relationship for assessing failsafety depends decisively on the fact that the inputs (126₃, 126₄) via which the electronic monitoring device (120) receives check signals from the sensors (150₃, 150₄) are configured in a functionally reliable manner: only if it is ensured that the probability for faulty signals lies below a specific threshold can a reliable statement about the presence of an operational relationship be made at all. However, a reliable statement which is obtained in this way and which is determined by the electronic monitoring device (120) must reach the safety system (300) in an equally reliable manner: it is only in the safety system (300) that it is possible to assess whether a safety-instrumented function in its entirety satisfies specific requirements with respect to failsafety. On account of the fact that the failsafety of a safety-instrumented function is limited by that component of the safety-instrumented function which has the highest failure probability (i.e. the lowest SIL level), the communication of the electronic monitoring device (120) with the safety system (300) must also take place via a connection (122) which is configured in a functionally safe manner. If the electronic monitoring device (120) determines, by using inputs (126₃, 126₄) which are configured in a functionally safe manner, for example for a specific part of the actuator valve, failsafety which satisfies the requirements according to SIL3, this evidence would be worthless if it were transmitted to the safety system (300) via a connection (122) which satisfies only the requirements according to SIL2. Only the combination of inputs (126₃, 126₄) which are configured in a functionally safe manner and a connection (122) which is configured in a functionally safe manner allows the safety system (300) to use the evidence which is generated by the electronic monitoring device (120) by monitoring an operational relationship between a check signal and a trigger signal for assessing the functional safety.

The connections (210, 212, 214, 310) can be, for example, Ethernet APL connections which may be configured in a functionally safe manner; correspondingly, the connection (122) and the input (124) can also be configured as Ethernet APL connections. In this case, the Ethernet APL standard is a configuration of the Ethernet protocol which is specifically tailored to the requirements of process engineering plants and which differs from the standard Ethernet standard by a specific configuration of the lowest protocol layer—considered in the OSI model—namely the physical layer (PHY for short). While, for example, the so-called fast Ethernet (100 Mbit/s) uses only four wire pairs on the physical layer of generally eight existing twisted wire pairs, all eight twisted wire pairs are required in the case of the so-called gigabit Ethernet (1000 Mbit/s) in order to be able to provide the higher transmission speed. Contrary to this fundamental trend toward an ever higher transmission speed, only a single twisted wire pair is used in the case of Ethernet APL, which limits the transmission speed to 10 Mbit/s. In comparison with conventional communication protocols which are usually used in the process industry and with which generally only transmission speeds in the range of a few kbit/s can be achieved, the low transmission speed of 10 Mbit/s—compared with the requirements of modern wired networks—nevertheless represents an enormous increase. In view of the fact that no large amounts of data are transmitted via the connections (210, 212, 214, 310), the transmission speed of only 10 Mbit/s is completely sufficient. In the context of process engineering plants, high safety requirements prevail instead of a transmission speed which is as high as possible. Thus, in the case of the energy supply of electric and electronic devices in the Ex-zone 0 or the Ex-zone 1, it must be ensured that the current intensities and voltages are limited in such a way that, even in the presence of an ignitable or even explosive mixture, no ignition source arises which could lead to an ignition or even to an explosion. An electric or electronic device or an electric connection which—depending on the respective Ex-zone—satisfies these requirements is referred to as intrinsically safe (Ex-i for short). Ethernet APL meets these requirements for intrinsic safety and is thus designed for operation within explosive areas, which is an essential requirement in particular in the process industry.

Furthermore, the connections (130₂, 1303, 130₄, 210, 212, 214, 310) and the associated connections (126₂, 1263, 1264, 122, 124) can be configured in a functionally reliable manner. With regard to the connections, the functionally safe configuration can be achieved by various circuit-technical measures and diagnostic measures which have already been explained in detail further above. At the level of the communication protocols, specific requirements for functional safety can be met by a functionally safe communication protocol being superimposed on a non-functionally safe communication protocol which is referred to as a “black channel.” An example of a functionally safe communication protocol which can be superimposed on the Ethernet APL connection is the PROFIsafe communication protocol or a CIPsafety protocol.

FIG. 1B shows an exemplary embodiment of an actuating device (100) which, with the exception of another type of connection of the actuating device (100) to the process control system (200) and the associated changed possibilities, can correspond to the exemplary embodiment of an actuating device (100) illustrated in FIG. 1A. While, according to the illustration, the connection (210) can branch downwards (“downstream”) into a connection (212) and a connection (214) in FIG. 1A, such a branching can be absent in the case of the actuating device illustrated in FIG. 1B. This can have the consequence that initially only the position controller (140₁)—but not the electronic monitoring device (120)—receives a trigger signal from the process control system (200). However, this trigger signal can subsequently be forwarded by the position controller (140₁) via a connection (216) to an electronic monitoring device (120) and received there at an input (124). In this case, the connection (210) between the process control system (200) and the position controller (140₁) and the connection (216) between the position controller (140₁) and the electronic monitoring device (120) do not have to be configured in a functionally reliable manner. Such a requirement of a functionally safe configuration of the connection would be on account of the fact that neither the outputs of the sensors (150₁, 150₂, 1503, 1504, 150₅) nor the outputs of a position controller (140₁) or of the solenoid valve (140₂) are configured in a functionally reliable manner as a rule, since a functionally safe configuration of these components would be associated both with a high design and financial outlay. In the case of advanced sensors, position controllers or solenoid valves which—contrary to the rule—themselves have outputs configured in a functionally reliable manner, the connections between these and the electronic monitoring device (120) can also be configured in a functionally reliable manner. Irrespective of whether the connection is configured in a functionally reliable manner or not, the connections (126₂, 126₃, 126₄) can be configured in a functionally reliable manner as a rule.

The type of connection of the actuating device (100) to the process control system (200) according to the exemplary embodiment illustrated in FIG. 1B can additionally allow a modified mode of operation. Whereas the trigger signal can originate in each case from the process control system (200) both in the exemplary embodiment illustrated in FIG. 1A and in the exemplary embodiment illustrated in FIG. 1B, the exemplary embodiment illustrated in FIG. 1B can allow a trigger signal to originate from the safety system (300) and to be received at the input (122) of the electronic monitoring device (120). Subsequently, the trigger signal can be forwarded, for example, via a connection (124) which functions as an output to an electric actuator (140₁).

The electronic monitoring device (120) can comprise an optional modular addition.

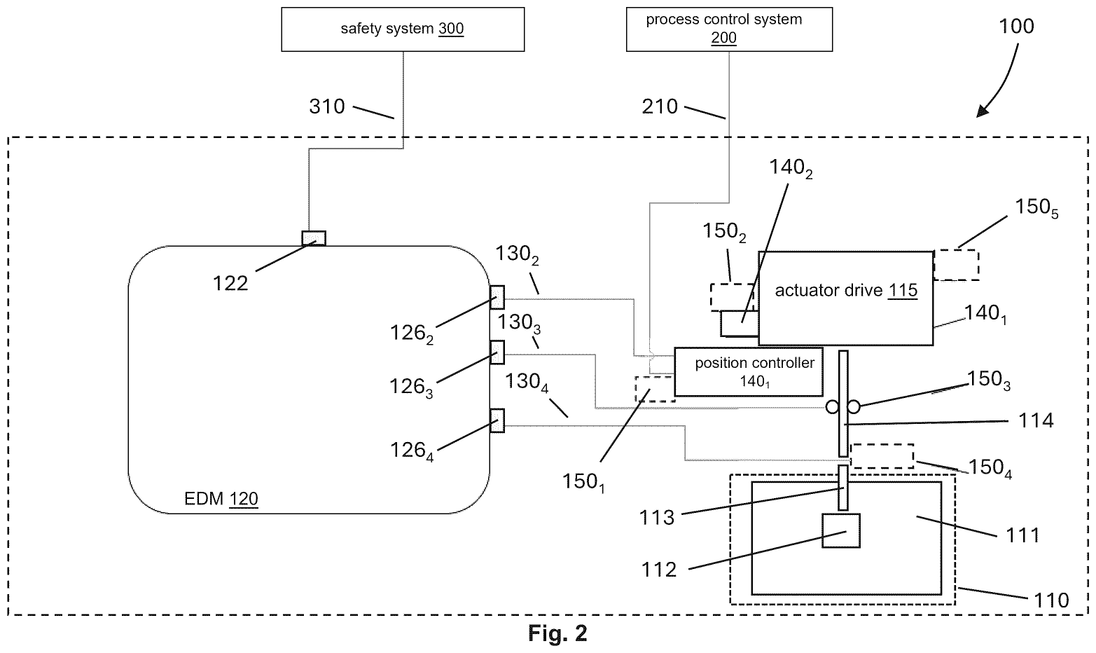

FIG. 2 shows an exemplary embodiment of an actuating device (100) which can execute a test function, such as a partial or full stroke test. The exemplary embodiment of an actuating device (100) illustrated in FIG. 2 differs from the exemplary embodiment illustrated in FIG. 1A by a reduced complexity. In contrast to the exemplary embodiment from FIG. 1A, the connection (130₂) between the actuator (140₁) and the connection (126₂) can be bidirectional; this can mean that the connection (126₂) can function both as an output and as an input. If—as described, for example, with regard to FIG. 1A—the actuator (140₁) receives a trigger signal from the process control system (200), the actuator (140₁) can subsequently forward the trigger signal via the connection (130₂) and the input (126₂) to the electronic monitoring device (120). Conversely—as described, for example, with regard to FIG. 1B—first of all the electronic monitoring device (120) can receive via the connection (122) a trigger signal which can subsequently be forwarded at the output (126₂) via the connection (1302) to the actuator (140₁). All the other components can have the same function and characteristics as in the exemplary embodiments which have been described with regard to FIGS. 1a and 1b.

The features disclosed in the preceding description, the figures and the claims can be significant both individually and in any desired combination for the realization of the disclosure in the different configurations.

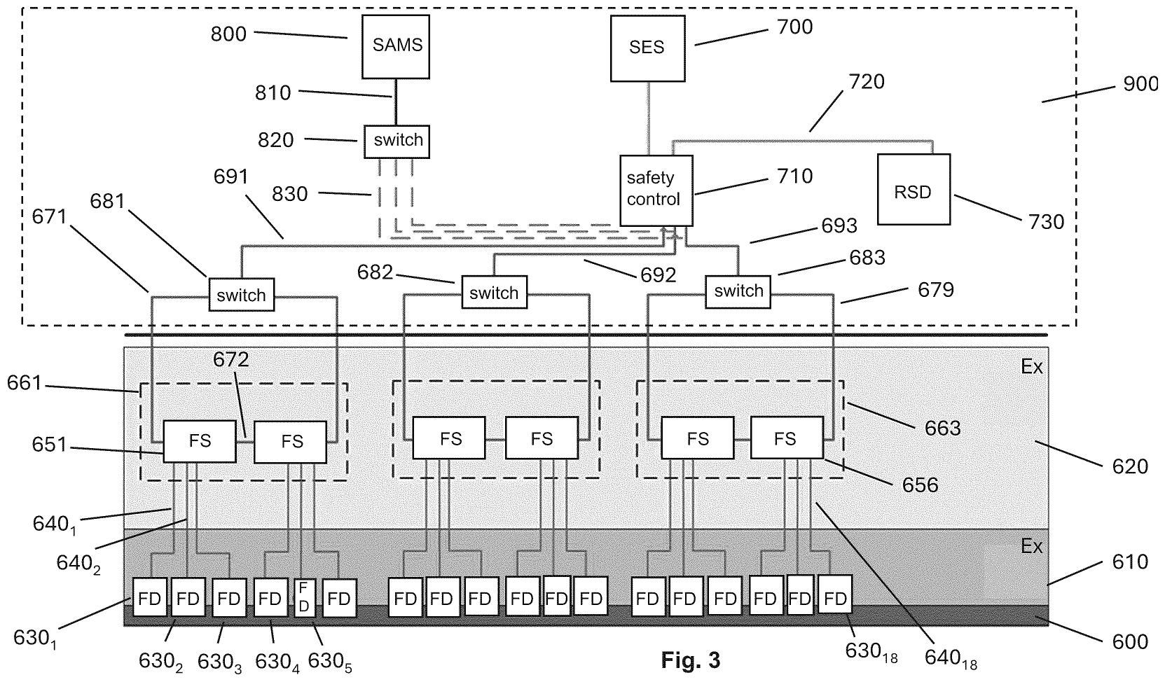

FIG. 3 shows a schematic illustration of selected components of a safety system of a process engineering plant and the assignment thereof to zones with different degrees of explosive hazards. An Ex-zone 0 (600) is, according to the operational safety regulation (BetrSichV) and the hazardous material regulation (GefStoffV), an area in which a dangerous explosive atmosphere as a mixture of air and combustible gases, vapors or mist is present constantly, over long periods of time or frequently. An Ex-zone 1 (610) is likewise, according to the operational safety regulation (BetrSichV) and the hazardous material regulation (GefStoffV), an area in which, during normal operation, a dangerous explosive atmosphere can occasionally form as a mixture of air and combustible gases, vapors or mists. Furthermore, an Ex-zone 2 (620) is, according to the operational safety regulation (BetrSichV) and the hazardous material regulation (GefStoffV), an area in which, during normal operation, a dangerous explosive atmosphere as a mixture of air and combustible gases, vapors or mists does not normally occur, and if so, only rarely and for a short time.

At the boundary between Ex-zone 0 (600) and Ex-zone 1 (610), different field devices (630₁-630₁₈) are arranged, each of which is connected via a respective communication link (640₁-640₁₈) to one of a plurality of switches (651-656) located in the field, which can be referred to as “field switches.” The communication links between the field devices and the field switches can use, for example, an Ethernet APL connection; in this case, the field switches (651-656) can be referred to, for example, as “API, field switches.” One or a plurality of the field switches (651-656) can be combined to form one or a plurality of groups (661-663) which, according to the illustration, are indicated by dashed lines.

Each of the field switches (651-656) can be connected within one of the groups (661-663) to one or a plurality of other field switches located in the same group via communication links (672, 675, 678). The communication links (672, 675, 678) can use a communication protocol which is configured in a functionally safe manner; likewise, the communication links (672, 675, 678) can use a combination of a communication connection which is not configured in a functionally safe manner, such as, for example, an Ethernet APL connection as a black channel and a communication protocol which is configured in a functionally safe manner and is based thereon, such as, for example, a PROFIsafe communication protocol or a CIPsafety protocol. Alternatively or additionally, each of the field switches (651-656) can be connected via a respective communication link (671, 673, 674, 676, 677, 679) to a switch (681-683) located outside the explosive areas. The communication links (671, 673, 674, 676, 677, 679) can also use a communication protocol which is configured in a functionally safe manner; likewise, the communication links (671, 673, 674, 676, 677, 679) can use a combination of a communication connection which is not configured in a functionally safe manner, such as, for example, an Ethernet APL connection as a black channel and a communication protocol which is configured in a functionally safe manner and is based thereon, such as, for example, a PROFIsafe communication protocol or a CIPsafety protocol.

According to the illustration, the switches (681-683) can be arranged outside (900) the explosive areas, said switches for their part in turn being connected via communication links (691-693) which are configured in a functionally safe manner to a safety control (“safety process control logic”, SPLC for short) (710). Within the safety system, the safety control (710) is connected via a communication link (720) having a protocol for the platform-independent exchange of data, such as of machine data, to a redundant safety device (“dual check safety”, DCS for short) (730); a communication protocol used in this communication can be, for example, an “Open Platforms Communication Unified Architecture” (OPC UA) protocol. According to the illustration, the safety control (710) is superordinated by an instance having safety engineering software (“safety engineering software”, Safety ES for short) (700) for controlling and programming the safety control (710).

Likewise located outside (900) the explosive areas can be a safety asset management system (Safety AMS for short) (800) which is connected via a standard communication protocol, such as, for example, an Ethernet communication protocol, to a switch (820). One or a plurality of connections (830) can exist between the switch (820) and the safety control (710).

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

The various components described herein may be referred to as “modules,” “units,” or “devices.” Such components may be implemented via any suitable combination of hardware and/or software components as applicable and/or known to achieve their intended respective functionality. This may include mechanical and/or electrical components, processors, processing circuitry, or other suitable hardware components, in addition to or instead of those discussed herein. Such components may be configured to operate independently, or configured to execute instructions or computer programs that are stored on a suitable computer-readable medium. Regardless of the particular implementation, such modules, units, or devices, as applicable and relevant, may alternatively be referred to herein as “circuitry,” “controllers,” “processors,” or “processing circuitry,” or alternatively as noted herein.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The following is a list of reference characters/numerals:
100 Actuating device
110 Control valve
111 Valve body
112 Valve cone
113 Valve spindle
114 Drive spindle
115 Actuating drive
120 Electronic monitoring device
121 Modular addition to the electronic monitoring device
122 Connection (configured in a functionally safe manner)
124 Connection (not necessarily configured in a functionally safe manner)
126₂ Connection (configured in a functionally safe manner)
126₃, 126₄ Inputs (configured in a functionally safe manner)
130₂-130₄ Connections (configured in a functionally safe manner)
132₂ Outgoing signal (functionally safe)
132₃, 132₄ Check signals (functionally safe)
132₅ Outgoing signal (not functionally safe)
140₁ Actuator (position controller)
140₂ Actuator (solenoid valve)
150₁, 150₂, sensor
150₃ Sensor (limit signal transmitter)
150₄ sensor
150₅ Sensor (alternative position)
200 Process control system
210 Connection (not necessarily configured in a functionally safe manner)
212 Connection (not necessarily configured in a functionally safe manner)
214 Connection (not necessarily configured in a functionally safe manner)
220 Switch
300 Safety system
310 Connection (configured in a functionally safe manner)
400 Execution of a test function (partial stroke test, full stroke test)
500 Execution of a test function (solenoid valve test)
600 Ex-zone 0
610 Ex-zone 1
620 Ex-zone 2
630₁-630₁₈ field devices
640₁-640₁₈ communication connections
651-656 field switches
661-663 groups of field switches
671 communication link (to outside the field; functionally safe)
672 communication link (within the field; functionally safe)
673 communication link (to outside the field; functionally safe)
674 communication link (to outside the field; functionally safe)
675 communication link (within the field; functionally safe)
676 communication link (to outside the field; functionally safe)
677 communication link (to outside the field; functionally safe)
678 communication link (within the field; functionally safe)
679 communication link (to outside the field; functionally safe)
681-683 switches (outside the field)
691-693 communication links (outside the field; functionally safe)
700 instance having safety engineering software
710 safety control
720 communication connection
730 redundant safety device
800 safety asset management system
810 communication link
820 switch
830 communication links
900 area outside explosive areas

1. An actuator device of a process engineering plant, comprising:
a control valve including:
an electric actuator configured to execute a test function, and
at least one sensor configured to check the execution of the test function and to transmit a check signal corresponding to the execution of the test function; and
an electronic monitoring device including:
a first input interface configured to receive an electrical trigger signal associated with a point in time of the triggering of the test function, and
a second input formed in a functionally safe manner and configured to receive the check signal of the at least one sensor, and
an electronics system configured to monitor an operational relationship between the check signal and the trigger signal.

2. The actuator device according to claim 1, wherein the at least one sensor is a limit contactor, a pressure sensor, or a stroke sensor.

3. The actuator device according to claim 1, wherein the trigger signal is a binary signal output by the electric actuator.

4. The actuator device according to claim 1, wherein the first input interface is configured in a functionally safe manner and is connected to a safety circuit of the process engineering plant via an Ethernet Advanced Physical Layer (APL) connection.

5. The actuator device according to claim 4, wherein the first input interface configured in the functionally safe manner comprises a combination of a functionally safe communication protocol and a communication connection acting as a black channel.

6. The actuator device according to claim 5, wherein the functionally safe communication protocol is a PROFIsafe protocol or a CIPsafety protocol.

7. The actuator device according to claim 5, wherein the communication connection acting as the black channel is an Ethernet APL connection.

8. The actuator device according to claim 1, wherein the electronic monitoring device is configured to be intrinsically safe.

9. The actuator device according to claim 1, wherein the execution of a test function comprises execution of a partial or full stroke test of the control valve.

10. The actuator device according to claim 1, wherein the check signal corresponding to the execution of the test function comprises information about a start, an end, and/or a course of the execution of the test function.

11. The actuator device according to claim 10, wherein the information about the course of the execution of the test functions indicates a switching of a limit contact, a duration until the switching of the limit contact, a duration until the switching and a duration until the switching back of the limit contact, an evaluation of a time course of a stroke movement, an evaluation of a completed stroke, an evaluation of a time course of a pressure, an evaluation of a pressure difference, and/or an evaluation of a pressure change rate.

12. The actuator device according to claim 10, wherein the check signal comprises information about a time course of the execution of the test function, the monitoring of the operational relationship between the check signal and the trigger signal comprises a division of the time course into different movement ranges of the test function.

13. The actuator device according to claim 1, wherein the monitoring of the operational relationship between the check signal and the trigger signal comprises a determination of a presence of a signal course in the check signal that correlates in time with the triggering of the switching function.

14. The actuator device according to claim 1, wherein the monitoring of the operational relationship between the check signal and the trigger signal comprises a determination of a time offset between the check and trigger signals, and a comparison of the time offset with a stored or earlier determined reference value.

15. The actuator device according to claim 1, wherein the electronic monitoring device comprises an output interface configured in a functionally safe manner and configured to output a control signal to the electric actuator based on the trigger signal, wherein the control signal is configured to control the actuator to trigger the test function.

16. The actuator device according to claim 1, wherein the electric actuator is an I/P converter or a solenoid valve of a position controller, or a drive or an independent solenoid valve.

17. A method for monitoring, by an electronic monitoring device, an actuator device of a process engineering plant, the actuator including a control valve including an electric actuator configured to execute a test function, and at least one sensor configured to check the execution of the test function and to transmit a check signal based on the execution of the test function, the method comprising:
receiving, by the electronic monitoring device, an electrical trigger signal for the test function at a first input of the electronic monitoring device, wherein the trigger signal is associated with a point in time of the triggering of the test function;
receiving, by the electronic monitoring device, a check signal of the at least one sensor at a second input of the electronic monitoring device, wherein the second input is formed in a functionally safe manner; and
monitoring, by an electronics system of the electronic monitoring device, an operational relationship between the check signal and the trigger signal.

18. An electronic monitoring device for an actuator device, comprising:
a first input configured to receive an electrical trigger signal associated with a point in time of a triggering of a test function of an electric actuator;
a second input formed in a functionally safe manner and configured to receive a check signal of at least one sensor, the check signal being indicative of a status of the execution of the test function; and
an electronics system configured to monitor an operational relationship between the check signal and the trigger signal, wherein the electronic monitoring device is formed separately from the electric actuator.

19. The electronic monitoring device according to claim 18, wherein the electronics system is configured in a functionally safe manner.
